(19) United States
(12) Patent Application Publication
(10) Pub. No.: US 2010/0281676 A1
(43) Pub. Date: Nov. 11, 2010

(54) Method for making a high performance metal bat having a reactive hitting surface

(76) Inventors: Steven L. Anderson, Yorba Linda, CA (US); Joshua D. Sullivan, Yorba Linda, CA (US)

Correspondence Address: Morland C. Fischer, Suite 1300, 2030 Main Street, Irvine, CA, 92614, US

(21) Appl. No.: 12/387,554

(22) Filed: May 5, 2009

(51) Int. Cl. B23P 11/00

(52) U.S. Cl. 29/516; 29/527.4; 29/557; 29/525.14

(57) ABSTRACT

A method for making a metal bat of the kind used for playing baseball or softball and having a hollow metallic shell including a wide barrel at one end, a narrow handle at the opposite end, and a tapered portion laying therebetween. The bat shell is initially thinned such that the original thickness and the corresponding weight thereof are reduced. A reactive hitting surface is then applied over the thinned bat shell around at least the barrel. The reactive hitting surface is preferably a metallic sleeve or a metallic coating that is applied directly to the barrel. Accordingly, the reactive hitting surface and the barrel will flex in unison with one another as a single integral surface in response to a ball striking the bat, wherein to increase the performance of the bat. A weight is added inside the handle of the hollow shell to balance the bat after thinning the shell and applying the reactive hitting surface over the barrel.

### BACKGROUND OF THE INVENTION

1. Field of the Invention

This invention relates to a method for making a bat for playing softball or baseball. To increase performance and cause a ball to travel further after impact, the bat is provided with a reactive hitting surface which includes either a metallic sleeve or a metallic coating that surrounds an area of reduced wall thickness of the barrel.

2. Background Art

Metal bats have long been used to play baseball and softball. Conventional metal bats are typically manufactured from a hollow shell that runs continuously between the handle at which the bat is gripped to the barrel to which a ball is hit. Because of this continuous bat construction, there is no way to localize the hitting area of the bat so as to isolate the hitting area from other regions (i.e., the handle) of the bat. What is more, there is no particular region at which the barrel of the conventional metallic bat may easily flex in response to its impact with a ball, such that the entire bat remains relatively stiff during the batter's swing and subsequent contact with the ball.

As a consequence of the foregoing, conventional metal bats are typically inefficient and require the batter to exert a relatively large swinging force to drive the ball. In addition, such conventional metal bats do not readily dissipate the impact forces that are created during contact with the ball and, therefore, are undesirably susceptible to denting.

What is more, in order to generate maximum power using a conventional metal bat, the ball must strike the heart of the sweet spot which is typically located at the center of the barrel. In cases where the ball strikes the barrel at a location other than the sweet spot, the bat will be less reactive, whereby energy will be lost such that the distance traveled by the ball following impact will be reduced. Consequently, such conventional metallic bats having a limited hitting area of the barrel are generally ineffective when the ball is struck off center.

What would be desirable is a high-performance bat for playing baseball or softball having a highly-reactive hitting surface which extends over at least some of the barrel so as to drive a ball farther even when the ball strikes the barrel off center.

### SUMMARY OF THE INVENTION

A method for making a high performance metal bat is disclosed of the kind to be used for playing the game of baseball or softball. The bat includes a continuous hollow metallic shell having a relatively wide barrel at one end thereof for striking a ball, a relatively narrow handle at the opposite end at which to grip the bat, and a tapered intermediate portion between the barrel and the handle. To enhance the performance of the bat so as to drive a ball farther without the user having to modify his swing, the barrel of the bat is surrounded by a reactive hitting surface or launch pad. The hollow metallic shell is initially thinned such that each of the barrel, handle and intermediate taper has a reduced thickness relative to a conventional metallic bat shell. According to a first preferred embodiment, the reactive hitting surface is an external cylindrical metallic sleeve that is mechanically affixed (e.g., by swaging, gluing or brazing) in surrounding face-to-face engagement with the thinned barrel. According to a second preferred embodiment, the reactive hitting surface is an external metallic (e.g., nickel-iron) nanostructured coating that is chemically bonded (e.g., electroplated) over and around the thinned barrel. The reactive hitting surface and the barrel function as a single surface and flex in unison in response to a ball striking the bat. To evenly distribute the weight of the bat along the length thereof, a (e.g., steel) plug is located inside the handle. The plug has a weight to compensate for the weight that is removed from the metallic shell during thinning.

The reactive hitting surfaces herein disclosed may surround the metallic shell of the bat at a localized area of the barrel or extend the entire length of the barrel. A set of spaced, parallel-aligned strength-reinforcing ribs surround the metallic shell adjacent the reactive hitting surface to reduce the possibility of damage when a ball strikes the bat away from the barrel.

### BRIEF DESCRIPTION OF THE DRAWINGS

FIG. 1 shows a high-performance metal baseball or softball bat having a reactive hitting surface surrounding the barrel of a hollow metallic bat shell according to a first preferred embodiment;

FIG. 2 is a cross-section of the hollow bat shell taken along lines 2-2 of FIG. 1;

FIG. 3 shows the barrel of the metal bat having the reactive hitting surface of FIGS. 1 and 2 lying flush with the bat shell;

FIG. 4 shows a weighted plug located within the handle of the hollow bat shell of FIG. 1 to balance the weight of the bat at opposite ends thereof; and

FIGS. 5-7 illustrate the thickness of a hollow metallic bat shell before and after a reactive hitting surface is applied to the barrel thereof according to a second preferred embodiment.

### DESCRIPTION OF THE PREFERRED EMBODIMENT

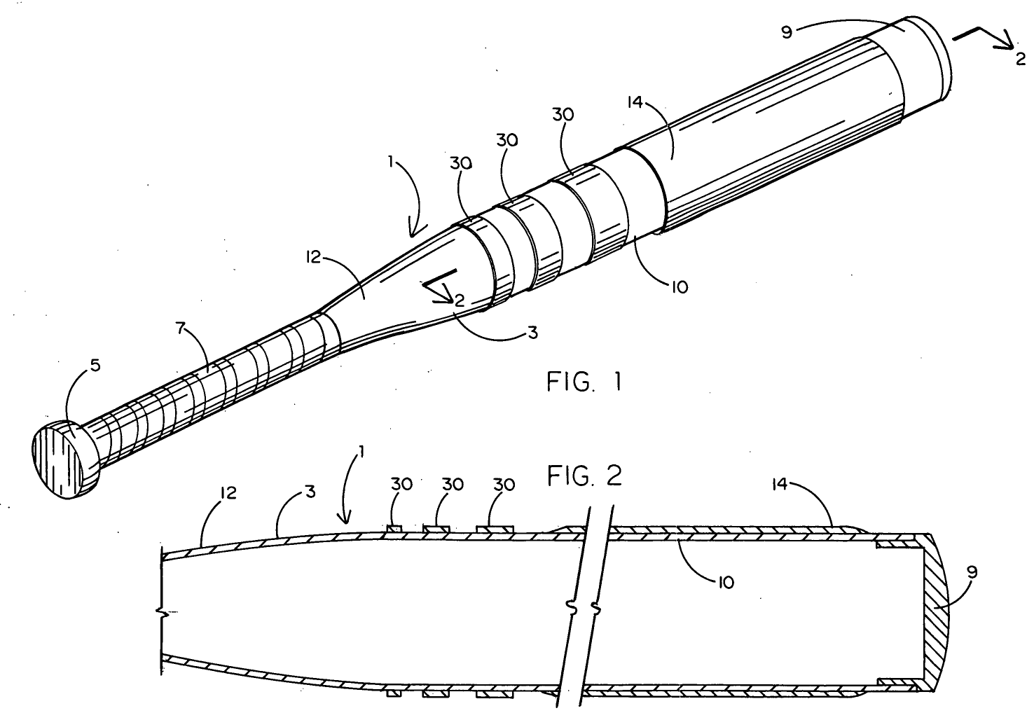

Referring initially to FIGS. 1 and 2 of the drawings, there is shown, according to a first preferred embodiment of this invention, a metal bat 1 of the kind typically used for playing baseball or softball. As is common to metal bats, the bat 1 shown in FIGS. 1 and 2 is of hollow construction and includes a cylindrical metallic (e.g., aluminum) shell 3 that runs continuously between an end-knob 5 of the relatively narrow handle 7 and an end-cap 9 of the relatively wide barrel 10. A tapered portion 12 extends between the handle 7 and the barrel 10 of the shell 3.

However, the shell 3 of the bat 1 shown in FIGS. 1 and 2 is manufactured (e.g., swaged) such that the thickness of the shell 3 will be less than the corresponding thickness found in a conventional metallic bat shell. That is to say, the usual thickness of barrel 10, the handle 7 and the taper 12 running therebetween is thinned so as to remove weight and make the shell 3 of the metal bat 1 lighter than the shell commonly used in the manufacture of a commercially-available metal bat.

To increase performance, at least the barrel 10 of the bat 1 is surrounded by a reactive hitting surface 14 or launch pad that is adapted to cause a ball which strikes the bat 1 at the hitting surface 14 to travel a greater distance after impact than the distance that would otherwise have been traveled had the ball struck the barrel of a conventional metal bat. The reactive hitting surface 14 which surrounds the barrel 10 of the shell 3 is preferably an external cylindrical sleeve that is manufactured from metal (e.g., aluminum). The thickness of the hitting surface sleeve 14 surrounding the barrel 10 can be varied depending upon the application of the bat and the requirements of the user. However, the reactive hitting surface sleeve 14 must be sufficiently thick to provide reinforcement and thereby prevent the barrel 10 from denting when a ball strikes the bat. By way of example only, the hitting surface sleeve 14 can, in most situations, have a thickness of approximately 0.040 inches.

As an important detail in the method for manufacturing the bat 1, the hitting surface sleeve 14 is directly affixed in surrounding engagement with at least the barrel 10 of the shell 3. By way of one example, the hitting surface sleeve 14 can be press fit (i.e., swaged) to lie in face-to-face contact against the barrel 10. By way of another example, the hitting surface sleeve 14 can be affixed to the barrel 10 by means of an adhesive or by a heating (i.e., brazing) technique. Regardless of the method of affixation, the external reactive hitting surface sleeve 14 and the internal barrel 10 will function as a single integral surface (rather than as a pair of independent walls that are known to separate from one another during use) and flex in unison in response to a ball striking the bat 1. In the present case, and unlike a conventional double-walled bat shell, the shell 3 of bat 1 would be destroyed if the sleeve 14 were separated from the barrel 10.

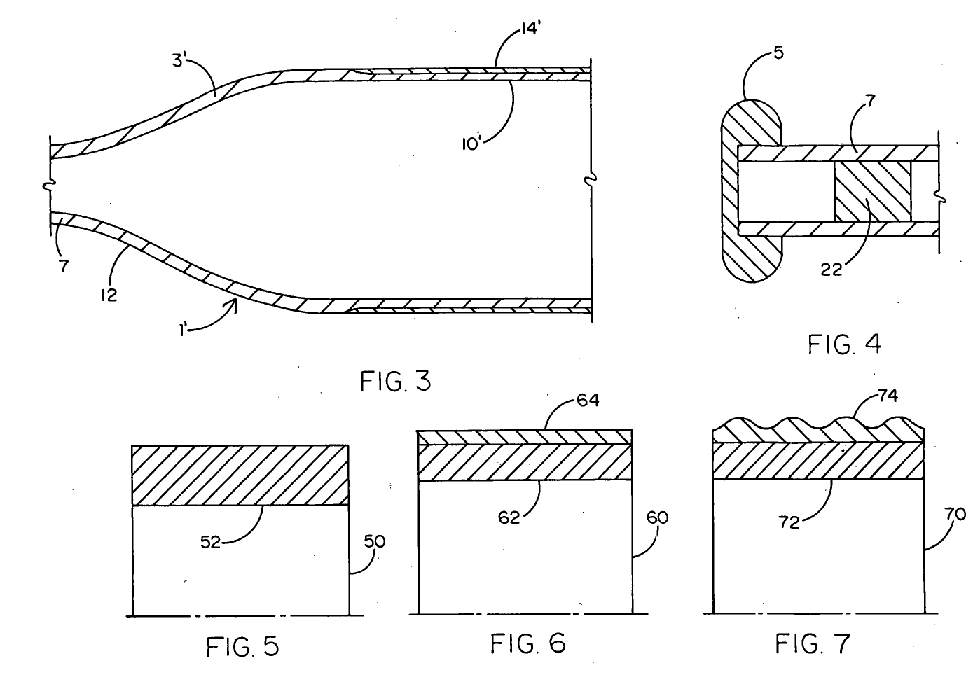

FIGS. 1 and 2 show the bat 1 where the shell 3 thereof has been initially thinned such that the reactive hitting surface sleeve 14 lies outside and above the shell 3. In this case, the opposite ends of the hitting surface sleeve 14 can be tapered (best shown in FIG. 2) to smoothly join the barrel 10. In an alternate embodiment shown in FIG. 3 of the drawings, the shell 3′ of the bat 1′ is initially thinned in a manner such that the reactive hitting surface sleeve 14′ surrounding the barrel 10′ will lie flush with the shell. In either embodiment, it is preferable that the combined thickness of the barrel 10 or 10′ and the reactive hitting surface sleeve 14 or 14′ be less than the thickness of the barrel of a conventional metallic bat which has not been subjected to thinning. Accordingly, the bat 1 and 1′ of FIGS. 1-3 will have a weight which is less than the weight of a conventional metal bat.

In other words, the weight removed from the metallic shells 3 and 3′ of the bats 1 and 1′ after being thinned is greater than the weight that is added to the shell following the reactive hitting surface sleeve 14 or 14′ being applied in surrounding engagement with at least the barrel 10 or 10′. To compensate for this net weight loss at the barrel, an equivalent weight is added to the opposite end of the bat at the hollow handle 7. Turning in this regard to FIG. 4 of the drawings, the weight added to the handle 7 is a solid cylindrical plug 22 that is preferably manufactured from steel, or the like. The plug 22 is ideally located within the handle 7 about six inches in front of the knob 5. However, the plug 22 can be manufactured from any other suitable weight-increasing material. By virtue of the plug 22, the weight of the bat 1 or 1′ will be balanced at the handle 7 and the barrel 10 or 10′ lying at opposite ends. Moreover, the moment of inertia (MOI) of the bats 1 and 1′ will be reduced as more weight is shifted to the handle 7. Therefore, the bats 1 and 1′ are likely to deliver better performance and drive a ball farther than a conventional bat striking a ball with an identical swing.

It is to be understood that the reactive hitting surface sleeves 14 and 14′ illustrated in FIGS. 1-3 can surround the metallic shell 3 or 3′ of the bat 1 or 1′ at a localized area of the barrel 10 or 10′ as shown or extend over at least the entire length of the barrel. In either event, the reactive hitting surfaces 14 and 14′ will enhance the reaction of the barrel 10 following impact with a ball and improve the overall balance and performance of the bat while meeting the certification requirements necessary for the bat to be used during competition.

There is also shown in FIGS. 1 and 2 a set of spaced, parallel-aligned strength-reinforcing ribs or struts 30 surrounding the metallic shell 3 of the bat 1 between the taper 12 and the reactive hitting surface sleeve 14 around the barrel 10. However, it is to be understood that more than one set of ribs 30 having the same or different numbers of ribs can be distributed along the shell 3. The ribs 30 have successive widths that vary from relatively thin to relatively wide in the direction of the longitudinal axis of the bat from the handle 7 to the end cap 9. Moreover, the distance between successive ones of the ribs 30 increases in the direction of the longitudinal axis from the handle 7 to the end cap 9. The ribs 30 may be identical in manufacture to the metallic sleeve which forms the reactive hitting surface 14 around the barrel 10. The set or sets of ribs 30 reinforce and strengthen the thinned shell 3 so as to advantageously reduce the possibility of denting as a consequence of the impact force generated when a ball strikes the bat away from the barrel 10.

FIGS. 5-7 of the drawings illustrate cross-sections of a metallic (e.g., aluminum) shell at the barrel of a metal bat before and after application of the reactive hitting surface according to another preferred embodiment of this invention. Prior to the application of the reactive hitting surface, the shell is manufactured (e.g., swaged) to have a thickness which is less than the thickness of a conventional metallic bat shell. Like that described while referring to the bats 1 and 1′ of FIGS. 1-3, the usual thickness of the shell at the barrel, the handle and the taper therebetween is thinned so as to remove weight and make the shell lighter than the shell used to make a commercially-available bat.

In order to improve the performance and balance of the bat, a reactive hitting surface is applied over at least the barrel of the thinned shell. In this case, the reactive hitting surface is an external metallic coating that is formed from a nanostructured nickel-iron material. By way of example, the coating which forms the hitting surface has an ideal thickness of approximately 0.003 inches and is chemically bonded to the shell so as to cover at least the barrel by means of a conventional electroplating process. One example of a nickel-iron coating to be bonded to the shell to form the reactive hitting surface is available by referring to Published United States Patent Application No. US2008/0234076. The reactive hitting surface coating may be applied to the barrel as a single relatively thick layer or as successive thinner layers applied one over the other.

Appearing below is a table to illustrate one example of the typical thickness in inches of the metallic shell of a conventional commercially-available bat of the kind used by an adult where the shell has not been subjected to thinning, the thickness in inches of the shell after being thinned according to the present embodiment, the ideal thickness in inches of the coating applied to the thinned barrel of the shell, and the final thickness in inches of the shell after the barrel has been coated in the manner described above to establish the reactive hitting surface thereover.

TABLE

| | THICK- | | | THICKNESS |
|---|---|---|---|---|
| | NESS | THICKNESS | THICK- | OF THINNED |
| | OF SHELL | OF SHELL | NESS | SHELL |
| | WITHOUT | AFTER | OF | AFTER |
| | THINNING | THINNING | COATING | COATING |
| BARREL | .100 | .092 | .003 | .095 |
| TAPER | .150 | .095 | | .095 |
| HANDLE | .095 | .080 | | .080 |

FIG. 5 illustrates a wall at the barrel 52 of a conventional hollow metallic bat shell 50 that is manufactured without being thinned. FIG. 6 illustrates a wall at the barrel 62 of a hollow metallic bat shell 60 that is thinned to reduce the thickness thereof relative to the usual wall thickness of the barrel 52 shown in FIG. 5. In this case, the aforementioned external coating 64 has been applied (i.e., coated) over the thinned shell 60 to provide structural reinforcement for and establish the reactive hitting surface around the barrel 62. It may be appreciated that the diameter of the shell 60 is increased by the application of coating 64, while the total thickness of the barrel 62 and the coating 64 shown in FIG. 6 is less than the thickness of the barrel 52 of the shell 50 of FIG. 5 which has not been thinned or coated. To account for a net weight reduction of the thinned wall shell 60 after the coating 64 is applied to the barrel 62, a weight (identical to that designated 22 in FIG. 4) may be added to the handle in order to balance the bat at its opposite ends as was previously disclosed.

The coating applied to the barrel of the thinned shell may vary in thickness and/or in shape. As shown in FIG. 6, the coating 64 which forms the reactive hitting surface around the barrel 62 of the shell 60 has a uniform shape and thickness. In the example of FIG. 7, the coating 74 around the barrel 72 of the shell 70 has a varying shape and a corresponding thickness which varies, for example, from 0.001 to 0.005 inches. In either one of the examples of FIGS. 6 and 7, the coatings 64 and 74 are bonded directly to the shells 60 and 70 such that the barrels 62 and 72 and the reactive hitting surface coatings 64 and 74 bonded thereover will respond to an impact force by flexing together as a single integral surface so as to improve the overall balance, performance, and power delivered by the bat.

The metal bat having a reactive hitting surface coating as just described may also include a set of spaced, parallel-aligned strength-reinforcing ribs or struts (designated 30 in FIGS. 1 and 2) which surrounds the metallic shell of the bat. Any such ribs or struts surrounding the metallic shell (designated 60 and 70 in FIGS. 6 and 7) would reinforce and strengthen the shell in the manner described above so as to advantageously reduce denting as a consequence of the impact force generated should a ball strike the bat away from the barrel 62 or 72.

The reactive hitting surfaces have been disclosed as being applied directly to a metallic bat shell. However, it is within the scope of this invention to apply the hitting surfaces to at least the barrel of a non-metallic bat having a non-metallic (e.g., composite) shell.

1. A method for making a bat for playing baseball or softball, said method comprising the steps of:
forming a hollow bat shell having a cylindrical barrel at one end at which a ball is struck, a cylindrical handle at the opposite end at which the bat is gripped, and a tapered region extending between the barrel and the handle, said bat shell having a first thickness and a corresponding first weight;
thinning said bat shell along at least the barrel, such that said bat shell has a second thickness at said barrel which is less than said first thickness and a corresponding second weight which is less than said first weight; and
applying a metallic coating to the thinned bat shell around at least the barrel thereof to increase the second weight of said bat shell, said metallic coating being applied directly to said barrel to form a reactive hitting surface for driving a ball that strikes the barrel and said coating applied thereover.

2. The method recited in claim 1, wherein said hollow bat shell is thinned along the barrel by swaging the bat shell from said first thickness to said second thickness.

3. The method recited in claim 1, wherein said metallic coating is applied around the thinned hollow bat shell at said barrel thereof by electroplating said coating directly to said bat shell.

4. The method recited in claim 1, wherein said metallic coating applied around the thinned hollow bat shell at said barrel thereof is manufactured from a metallic material containing nickel and iron.

5. The method recited in claim 1, wherein the thickness of said metallic coating that is applied around the hollow bat shell varies along the length of said barrel.

6. The method recited in claim 1, wherein the combined thickness of the hollow bat shell at said barrel thereof and said metallic coating that is applied around the barrel of said thinned shell is less than the thickness of said bat shell at said barrel prior to the step of thinning said bat shell.

7. The method recited in claim 1, wherein the combined weight of said hollow bat shell after the steps of thinning the bat shell and applying said metallic coating around the thinned bat shell at said barrel is less than the first weight of said bat shell prior to said thinning step, said method comprising the additional step of adding additional weight to said bat shell such that the combined weight of the thinned bat shell, the coating applied around the barrel thereof, and said additional weight equals the first weight of said bat shell.

8. The method recited in claim 7, wherein said additional weight added to said hollow bat shell is located within the handle thereof.

9. The method recited in claim 1, including the additional step of applying a set of reinforcing ribs that are spaced from one another around said hollow bat shell at a location between the metallic coating applied around the barrel of said bat shell and said tapered region thereof.

10. The method recited in claim 9, including the additional step of making at least some of the reinforcing ribs of said set of ribs wider than other ones of said ribs.

11. The method recited in claim 9, including the additional step of varying the spacing between successive ones of the reinforcing ribs of said set of ribs.

12. A method for making a bat for playing baseball or softball, said method comprising the steps of:
forming a hollow bat shell having a cylindrical barrel at one end at which a ball is struck, a cylindrical handle at the opposite end at which the bat is gripped, and a tapered region extending between the barrel and the handle, said bat shell having a first thickness and a corresponding first weight;
thinning said bat shell along at least the barrel, such that said bat shell has a second thickness at said barrel which is less than said first thickness and a corresponding second weight which is less than said first weight; and
applying a cylindrical metallic sleeve in surrounding face-to-face engagement with the thinned wall of the bat shell over at least the barrel thereof to increase the second weight of said bat shell, said cylindrical metallic sleeve forming a reactive hitting surface for driving a ball that strikes the sleeve surrounding the barrel.

13. The method recited in claim 12, including the additional step of fixedly attaching said cylindrical metallic sleeve to the barrel of the thinned hollow bat shell such that said barrel and said sleeve are integrally connected together so as to flex in unison in response to a ball striking the sleeve surrounding the barrel.

14. The method recited in claim 13, wherein said cylindrical metallic sleeve is fixedly attached to the barrel of the thinned hollow bat shell by means of swaging.

15. The method recited in claim 13, wherein said cylindrical metallic sleeve is fixedly attached to the barrel of the thinned hollow bat shell by means of brazing.

16. The method recited in claim 12, wherein the combined weight of said hollow bat shell after the steps of thinning said bat shell and applying said cylindrical metallic sleeve in surrounding face-to-face engagement with the thinned bat shell at said barrel is less than the first weight of said bat shell prior to said thinning step, said method comprising the additional step of adding additional weight to said bat shell such that the combined weight of the thinned bat shell, the cylindrical metallic sleeve surrounding the barrel, and said additional weight equals the first weight of said bat shell.

17. The method recited in claim 16, wherein said additional weight added to said hollow bat shell is located within the handle thereof.

18. The method recited in claim 12, including the additional step of applying a set of reinforcing ribs that are spaced from one another around said hollow bat shell at a location between said cylindrical metallic sleeve surrounding the barrel of said bat shell and the tapered region of said bat shell.

19. The method recited in claim 18, including the additional step of making at least some of the reinforcing ribs of said set of ribs wider than other ones of said ribs.

20. The method recited in claim 18, including the additional step of varying the spacing between successive ones of the reinforcing ribs of said set of ribs.
